(19) United States
(12) Patent Application Publication
(10) Pub. No.: US 2011/0029881 A1
(43) Pub. Date: Feb. 3, 2011

(54) DEVICES AND METHODS FOR PROVIDING SOFTWARE PROGRAMS COMPATIBLE WITH A COMPUTER SYSTEM FOR DOWNLOAD BY A USER

(75) Inventors: Matthew Smith, Studio City, CA (US); Joseph Greenfield, Los Angeles, CA (US); Jason Adams, Camarillo, CA (US)

Correspondence Address: LOZA & LOZA LLP, 305 North Second Ave., #127, Upland, CA, 91786, US

(73) Assignee: NEVOLUTION DIGITAL, LLC, Encino, CA (US)

(21) Appl. No.: 12/901,882

(22) Filed: Oct. 11, 2010

(51) Int. Cl. G06F 15/177

(52) U.S. Cl. 715/735

(57) ABSTRACT

Devices and methods are provided for determining the compatibility of software programs for a computer system and providing a list of the compatible software programs for a user of the computer system.

### BACKGROUND

Distributing digital content, such as software, generally occurs either by downloading such content from a website or by downloading it from a physical medium such as an optical disk (e.g., CD ROM, DVD ROM). Website based software distribution has the advantage of requiring very little infrastructure. However, websites are often insecure, and are vulnerable to hacking and piracy.

Both website-based and physical distribution methods for digital content such as software programs suffer from the fact that a user must have a certain technical understanding of computer systems in order to be able to evaluate whether a particular piece of software or other content will be compatible with the user's particular computer system, including software already installed on the user's system. In view of this, improved methods of distributing digital content are needed.

### SUMMARY

In one embodiment, the present invention relates to a computer system that includes a display device, a communication interface, and a processing circuit coupled to both the display device and the communication interface. The processing circuit in this embodiment is adapted to:
determine one or more configuration details of the computer system;
obtain, via the communication interface, a directory of a plurality of software programs, each software program is associated with a set of system requirements for the software program; and
display via the display device a list of software programs indicating each software program that has system requirements which are compatible with the configuration details of the computer system, the indicated software programs comprising compatible software programs.

In this embodiment, the obtained directory can include an indication of the compatible software programs. If the directory lacks an indication of the compatible software programs, the processing circuit can be further adapted to identify and generate a list of the compatible software programs.

Preferably, the displayed list of software programs comprises only the compatible software programs. Alternatively, the displayed list of software programs can comprise both the compatible software programs and one or more non-compatible software programs, and the compatible software programs can include an indicator of compatibility, such as highlighting, a star, or an arrow.

In another embodiment, the present invention comprises a method, operational in a computer system, comprising the steps of:

determining one or more configuration details of the computer system;

obtaining a directory of a plurality of software programs, each software program is associated with a set of system requirements for the software program; and

displaying a list of software programs indicating each software program that has system requirements which are compatible with the configuration details of the computer system, the indicated software programs comprising compatible software programs.

In this method, the step of obtaining a directory of software programs can include obtaining a directory of software programs which indicates the compatible programs, and then displaying the programs. Alternatively, the directory can be obtained without an indication of the compatible software programs, in which case the method further comprises identifying and generating a list of the compatible programs, which can be associated for example with an indicator such as highlighting, a star, or an arrow.

In a further embodiment, the present invention comprises a computer readable medium encoded with computer readable program code. The program code in this embodiment comprises:

instructions operable to determine one or more configuration details of a computer system;

instructions operable to obtain a directory of a plurality of software programs, each software program is associated with a set of system requirements for the software program; and

instructions operable to display a list of software programs indicating each software program that has system requirements which are compatible with the configuration details of the computer system, the indicated software programs comprising compatible software programs.

The instructions for obtaining a directory of a plurality of software programs preferably comprises instructions for obtaining a directory without an indication of the compatible software programs, in which case the computer readable medium further comprises instructions operable to identify the compatible software programs in the obtained directory of the plurality of software programs; and instructions operable to generate the list of software programs indicating each compatible software program.

In yet another embodiment, the present invention can comprise a server system that includes:

a communications interface;

a storage medium storing a catalog of a plurality of software programs, each software program is associated with a set of system requirements for the software program; and

a processing circuit coupled to the communications interface and the storage medium, the processing circuit being adapted to:
receive, via the communications interface, a request including one or more configuration details associated with a remote system;
generate a list of software programs indicating each software program that has system requirements which are compatible with the received configuration details, the indicated software programs comprising compatible software programs; and
convey, via the communications interface, a directory including the generated list of software programs indicating each compatible software program.

The server system in this embodiment, when generating a list of software programs, can include both the compatible software programs from the catalog and non-compatible software programs, or alternatively can include only compatible software programs. The processing circuit of the server is also preferably adapted to indicate each compatible software program by associating at least one indicator with each compatible software program.

Another embodiment of the present invention includes a method operational in a server system, comprising the steps of:

receiving a request from a remote system, the request including one or more configuration details associated with the remote system;

generating a list of software programs indicating each software program that has system requirements which are compatible with the received configuration details, the indicated software programs comprising compatible software programs; and

conveying a directory including the generated list of software programs indicating each compatible software program.

Generating the list of software programs can further include the step of filtering out any software programs from a catalog that are not compatible with the received configuration details, and/or associating at least one indicator with each compatible software program.

A further embodiment of the present invention comprises a computer readable medium encoded with computer readable program code, the program code comprising:

instructions operable to receive a request from a remote system, the request including one or more configuration details associated with the remote system;

instructions operable to generate a list of software programs indicating each software program that has system requirements which are compatible with the received configuration details, the indicated software programs comprising compatible software programs; and

instructions operable to convey a directory including the generated list of software programs indicating each compatible software program.

### DRAWINGS

FIG. 1 is a block diagram illustrating how one or more computer systems operate within a communication network.

FIG. 2 is a flow diagram illustrating the identification and display of a list of software programs compatible with the computer system according to at least one embodiment in which the compatible software programs are indicated by the server system.

FIG. 3 is a flow diagram illustrating the identification and display of a list of software programs compatible with the computer system according to at least one embodiment in which the compatible software programs are indicated by the computer system.

FIG. 4 is a block diagram illustrating select components of a computer system according to one or more embodiments.

FIG. 5 is a flow diagram illustrating at least one embodiment of a method operational on a computer system.

FIG. 6 is a block diagram illustrating select components of a server system according to at least one embodiment.

FIG. 7 is a flow diagram illustrating at least one embodiment of a method operational on a server system.

### DESCRIPTION

### Definitions

As used herein, the following terms and variations thereof have the meanings given below, unless a different meaning is clearly intended by the context in which such term is used.

“Adapted to,” in regard to a processing circuit, refers to the processing circuit being configured, employed, implemented, or programmed, as well as any combination thereof, to carry out some process, function, step or routine.

“Catalog” refers to a list of items (e.g., software programs). As used herein, a catalog can include a name or other identifier of the item. In some implementations, a catalog can include a description of the item or other information related to the item in addition to the name or other identifier.

“Compatible,” in regard to computer systems and software programs, refers to a computer system having or meeting the system requirements of a particular software program. That is, a particular software program can be compatible with a particular computer system if the computer system has at least the minimum and/or recommended configuration details (e.g., hardware components and/or software resources).

“Computer system” refers to any electronic data processing device adapted to execute software and that is adapted to communicate via a communication network. By way of example and not limitation, a computer system can include a desktop computer, a laptop computer, a notebook computer, a tablet (e.g., iPAD®), a personal media player (e.g., iPOD®, ZUNE®), a smart phone (e.g., iPHONE®, DROID®, BLACKBERRY®), or other data processing device.

“Configuration details” of a computer system refers to one or more hardware components and/or software resources of the computer system. By way of example and not limitation, “configuration details” can include processor performance capabilities (e.g., processor speed, processor type), memory capabilities, available secondary storage (e.g., hard disk space), display and graphics capabilities (e.g., display resolution, graphics card performance), operating system, available application programming interfaces (API), drivers, or other software programs (e.g., web browsers) or hardware (e.g., peripherals such as keyboards, pointing devices, cameras, network devices). Other hardware and/or software details/capabilities can also be included by the term “configuration details.”

“Software programs” refers to a collection of processor executable code or code segments that provide instructions telling the processor what to do. As used herein, the term “software programs” can include software, firmware, middleware, testware or microcode as well as any combination thereof. By way of example and not limitation, examples of software can include application software, system software, programming software, and gaming software (e.g., for video and computer games).

“System requirements,” in relation to software programs, refers to hardware components and/or other software resources present on a computer system that are considered to be prerequisites for a particular software program to operate efficiently and/or correctly. Such prerequisites are often set forth by the software publisher or developer, and typically indicate a guideline as opposed to an absolute rule. According to various implementations in the present disclosure, “system requirements” can refer to minimum system requirements and/or recommended system requirements. Minimum system requirements include the minimum hardware components and/or software resources required for a software program to operate as intended. Recommended system requirements include the suggested hardware components and/or software resources in order for the software program to operate at an intended or desired performance level.

By way of an example and not limitation, some system requirements can include processing power requirements, memory requirements, secondary storage requirements (e.g., hard disk space), display requirements (e.g., display resolution, graphics card requirements, graphics card memory), operating system requirements, application programming interface (API) requirements, driver requirements, or other software programs (e.g., web browsers) or hardware (e.g., peripherals such as keyboards, pointing devices, cameras, network devices), as well as combinations of one or more of the foregoing. Other hardware and/or software requirements can also be included for various types of software programs.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### System Overview

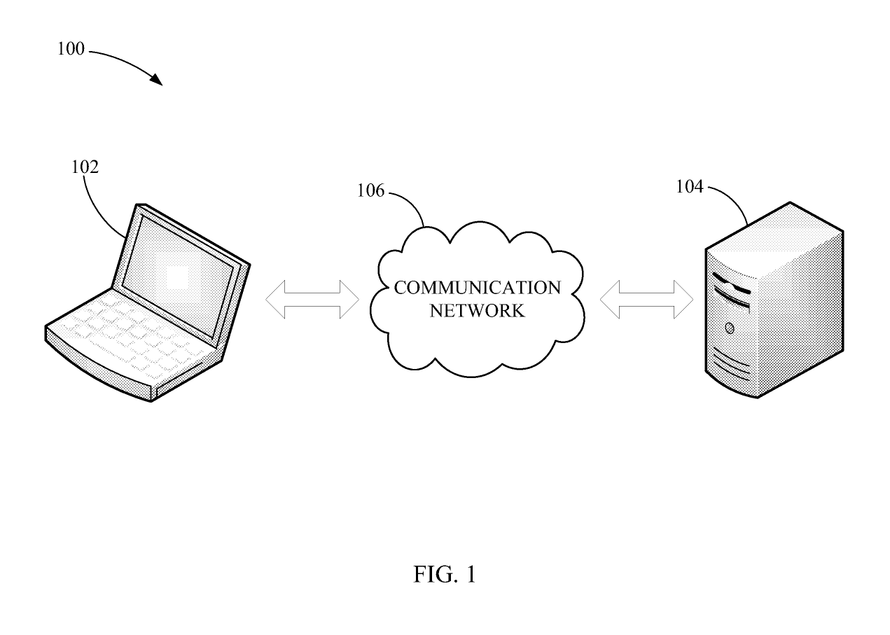

Various implementations of the present disclosure are directed to methods and systems for implementing a marketplace for the distribution (e.g., buying and selling) of software programs. According to at least one feature, software programs are identified and listed to indicate that particular software programs are compatible with a particular computer system. FIG. 1 is a block diagram illustrating how one or more computer systems operate within a communication network. A software delivery system 100 can include one or more computer systems 102 and one or more server systems 104 communicatively coupled via a communication network 106, such as the internet, an intranet, other communications network, or various combinations. The server system 104 includes a catalog of a plurality of software programs, and the computer system 102 can be adapted to communicate with the server system 104 via the communication network 106 for obtaining a directory of a plurality of software programs to be displayed to a user of the computer system 102.

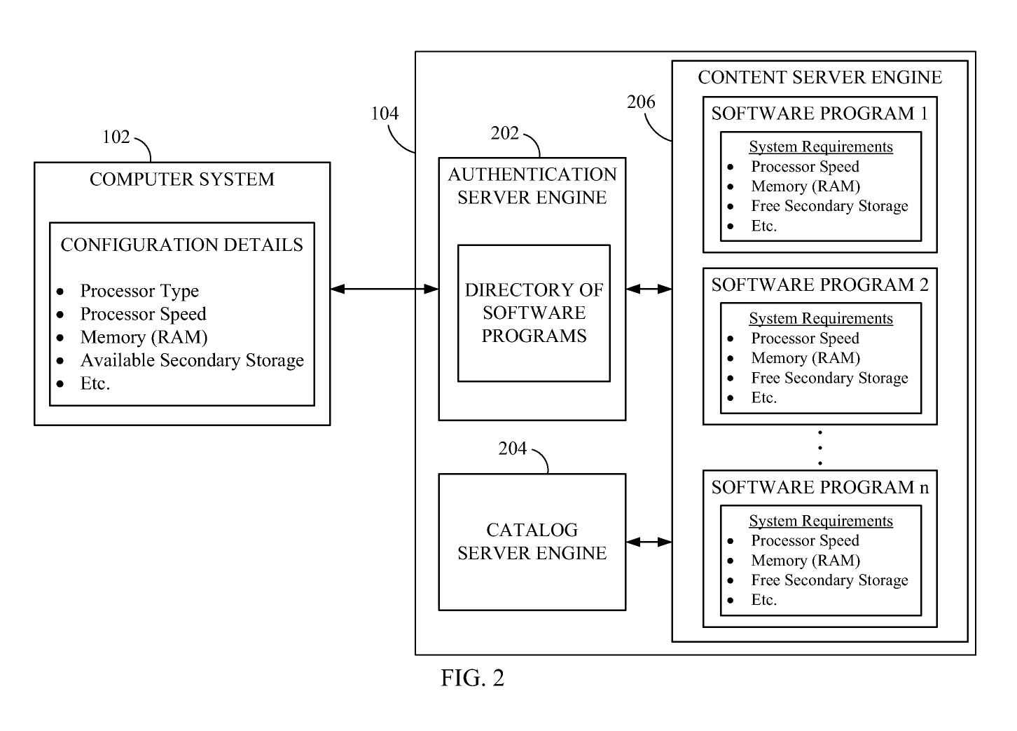

FIG. 2 illustrates a block diagram of select features and select components of the computer system and server system of FIG. 1. The server system 104 can include a plurality of server engines, such as an authentication server engine 202, a catalog server engine 204 and a content server engine 206. In the embodiment illustrated in FIG. 2, the content server engine 206 can contain the catalog of software programs. Each of the software programs in the catalog is associated with a set of system requirements (e.g., minimum and/or suggested). Such system requirements can be provided by the developer or publisher of the software program via the catalog server engine 204. According to at least one feature, the server system 104 can be adapted to enable a software developer or publisher to directly enter such system requirement specifications to be associated with a particular software program. For example, a software developer or publisher may log into a developer web portal and create a new product listing in the catalog server engine 204 for their new or upgraded software program. The developer or publisher can upload the necessary files associated with the new or upgraded software program (e.g. the program and program installation files) to the catalog server engine 204. At the time of uploading the new or upgraded software program to the catalog server engine 204, the developer or publisher specifies in the product listing at the catalog server engine 204 what the system requirements are for running the software program. After the software program is successfully uploaded, the server system 104 can add the software program in the catalog. In at least one implementation, the server system 104 can operate using a platform such as Microsoft's .NET environment, for example the WCF (Windows Communication Foundation) framework, in order to allow users to access information and features remotely and engage in the same workflow that would take place when using software resident on the user's computer system, such as computer system 102.

The computer system 102 is adapted to communicate with the server system 104 and to obtain a directory including a list of at least some of the software programs of the catalog of software programs. According to at least one embodiment, the computer system 102 can obtain a directory comprising a list of the entire catalog from the server system 104 via the authentication server engine 202. In such embodiments, the computer system 102 can indicate the software programs having system requirements that are compatible with the configuration details of the computer system 102 (e.g., hardware components and/or software resources of the computer system 102). According to one or more alternative embodiments, the server system 104 (via the content server engine 206) can filter the catalog according to the particular configuration details of the computer system 102 and can provide (via the authentication server 202) to the computer system 102 a directory comprising a list in which those software programs that are compatible with configuration details of the computer system 102 are indicated. In either case, the computer system 102 is adapted to display a list indicating the software programs that are compatible with the computer system 102.

The displayed list may comprise only those software programs indicated as compatible software programs. In other embodiments, the displayed list can comprise the compatible and non-compatible software programs, with the compatible software programs identified in the list by one or more indicators. For example, the compatible software programs can be highlighted, reordered with the compatible software programs listed first, indicated by a star, indicated by an arrow, or any other suitable indicator or combination of indicators.

Using the displayed list of software programs, a user can browse software programs that are compatible with the user's computer system 102. If the user identifies a desired software program, the user can download the software program from the list for installation on the user's computer system 102.

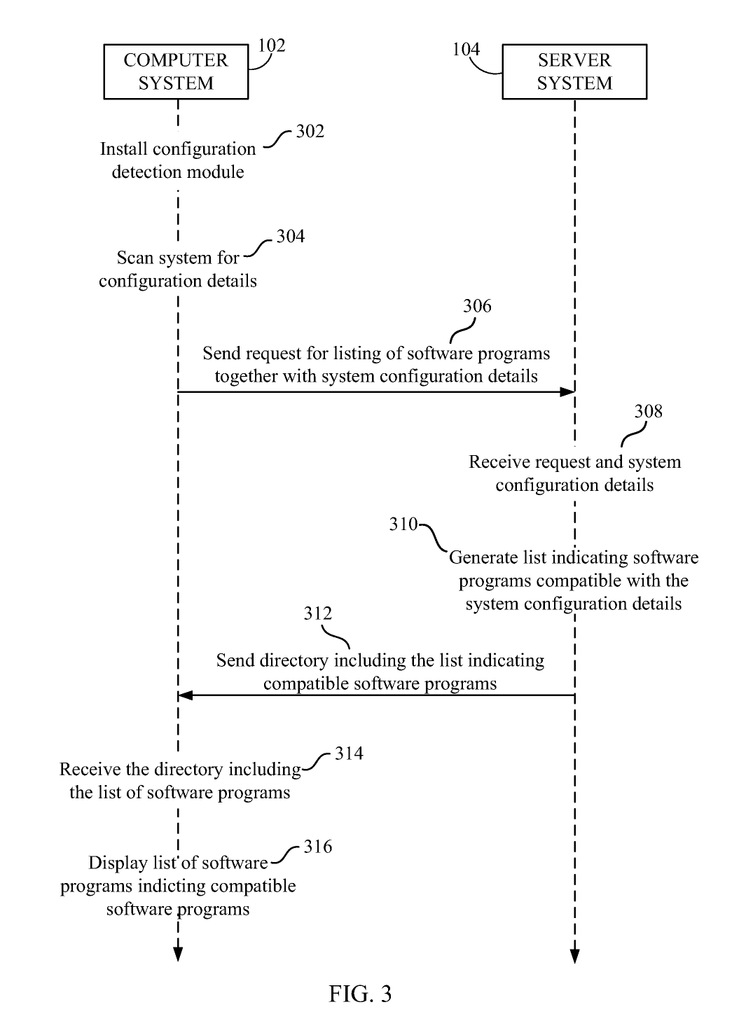

FIG. 3 is a flow diagram illustrating the identification and display of a list of software programs compatible with the computer system according to at least one embodiment in which the compatible software programs are indicated by the server system. In this example, the computer system 102 and the server system 104 of FIGS. 1 and 2 are used for illustration purposes. As part of the identification and display of compatible software programs, the computer system 102 can install a configuration detection module 302. Such a configuration detection module can comprise, according to some embodiments, a software application which, when executed by the computer system 102, causes the computer system 102 to obtain one or more system configuration details associated with the computer system 102.

With the configuration detection module installed, the configuration detection module can cause the computer system 102 to scan for one or more configuration details 304. By way of example and not limitation, the computer system 102 can scan for one or more configuration details including processor performance capabilities (e.g., processor speed, processor type), memory capabilities, available secondary storage (e.g., hard disk space), display and graphics capabilities (e.g., display resolution, graphics card performance), operating system, available application programming interfaces (API), drivers, or other software programs (e.g., web browsers) or hardware (e.g., peripherals such as keyboards, pointing devices, cameras, network devices). Other hardware and/or software details/capabilities can also be identified during the scan for configuration details.

After the configuration details associated with the computer system 102 are discovered, a message can be conveyed from the computer system 102 to the server system 104 requesting a list of software programs 306. The message can further include one or more of the discovered configuration details. The server system 104 can receive the request for a listing of software programs as well as the configuration details 308. As noted above with reference to FIG. 1, the server system 104 includes a catalog of a plurality of software programs. Using the system configuration details received from the computer system 102, the server system 104 can generate a list indicating the compatible software programs 310. For example, the server system 104 can identify each software program from the catalog that has system requirements that are compatible with the received system configuration details. In at least one implementation, the server system 104 can identify compatible software programs by employing the one or more system configuration details to filter out those software programs that are not compatible with the computer system 102, resulting in a list comprising only the compatible software programs. In another implementation, the server system 104 can employ the one or more system configuration details to provide an indicator for each compatible software program. For example, each compatible software program in the catalog can be highlighted, the catalog can be reordered with the compatible software programs located at the beginning, a star or an arrow can be positioned next to each compatible software program, or any other means for indicating the compatible software programs of the catalog, as well as combinations thereof.

A directory that includes the list indicating compatible software programs is conveyed 312 from the server system 104 to the computer system 102. The conveyed directory that includes the list indicating compatible software programs is received 314 by the computer system 102 and the computer system 102 can display the list of software programs 316. In this manner, a user of the computer system 102 is able to browse a list of one or more software programs and easily identify those software programs that are indicated as being compatible with the computer system 102, without needing to know the configuration details of the computer system 102.

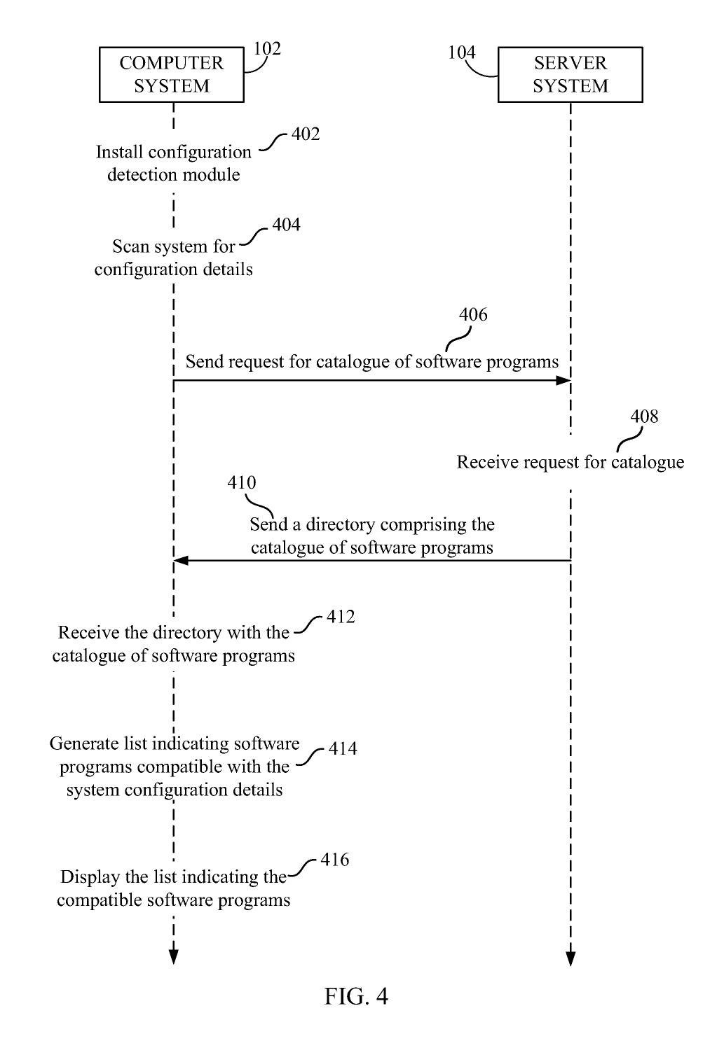

FIG. 4 is a flow diagram illustrating the identification and display of a list of software programs compatible with the computer system according to at least one embodiment in which the compatible software programs are indicated by the computer system. In this example, the computer system 102 and the server system 104 of FIG. 1 are again used for illustration purposes. As part of the identification and display of compatible software programs, the computer system 102 can install a configuration detection module 402. The configuration detection module can comprise, according to some embodiments, a software application which, when executed by the computer system 102, causes the computer system 102 to obtain one or more system configuration details associated with the computer system 102.

With the configuration detection module installed, the configuration detection module can cause the computer system 102 to scan for one or more configuration details 404. By way of example and not limitation, the computer system 102 can scan for one or more configuration details including processor performance capabilities (e.g., processor speed, processor type), memory capabilities, available secondary storage (e.g., hard disk space), display and graphics capabilities (e.g., display resolution, graphics card performance), operating system, available application programming interfaces (API), drivers, or other software programs (e.g., web browsers) or hardware (e.g., peripherals such as keyboards, pointing devices, cameras, network devices). Other hardware and/or software details/capabilities can also be identified during the scan for configuration details.

As noted, the server system 104 includes a catalog of a plurality of software programs. The computer system 102 can convey a message to the server system 104 requesting the catalog of software programs 406. The server system 104 can receive the request for the catalog of software programs 408, and the user system 104 can convey 410 a directory comprising the catalog of software programs to the computer system 102. The conveyed directory with the catalog of software programs is received 412 by the computer system 102. In the implementation illustrated in FIG. 4, the conveyed catalog included no indication of compatible software programs. The conveyed catalog simply includes a plurality of software programs, without any indication of whether a software program is compatible or not compatible.

The computer system 102 can generate a list indicating each software program from the catalog that has system requirements compatible with the system configuration details 414. For example, the computer system 102 can employ the system configuration details obtained from the system scan to identify each compatible software program from the catalog. In at least one implementation, the computer system 102 can identify compatible software programs by employing the one or more system configuration details to filter out those software programs that are not compatible with the computer system 102, resulting in a list comprising only the compatible software programs. In another implementation, the computer system 102 can employ the one or more system configuration details to associate an indicator to each compatible software program. For example, each compatible software program in the catalog can be highlighted, the catalog can be reordered with the compatible software programs located at the beginning, a star or an arrow can be positioned next to each compatible software program, or any other means for indicating the compatible software programs of the catalog, as well as combinations thereof.

The list of compatible software programs is then displayed 416 by the computer system 102. The user of the computer system 102 is again able to browse a list of one or more software programs and easily identify those software programs that are compatible with the computer system 102, without the need to know the configuration details of the computer system 102.

### Computer System

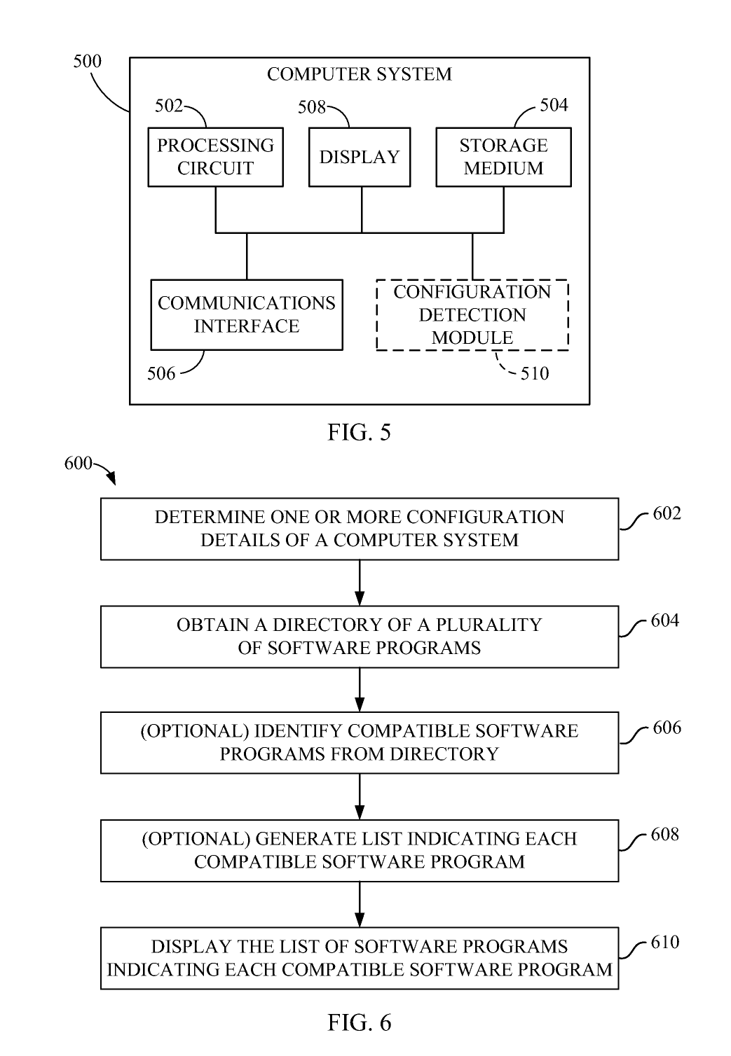

FIG. 5 is a block diagram illustrating select components of a computer system 500 according to one or more embodiments. The computer system 500 can be adapted to perform all of the features of the computer system 102 as set forth herein above with reference to FIGS. 1-4. As illustrated in FIG. 5, the computer system 500 can include a processing circuit 502 coupled to a storage medium 504, a communications interface 506 and a display 508. The computer system 500 can further include a configuration detection module 510. It is noted that additional, fewer and/or different features and components can be included in computer system 500 according to various embodiments.

The processing circuit 502 is arranged to obtain, process and/or send data, control data access and storage, issue commands, and control other desired operations. The processing circuit 502 can comprise circuitry configured to implement desired programming provided by appropriate media in at least one embodiment. For example, the processing circuit 502 can be implemented as one or more of a processor, a controller, a plurality of processors and/or other structure configured to execute executable instructions including, for example, software and/or firmware instructions, and/or hardware circuitry. Embodiments of the processing circuit 502 can include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor can be a microprocessor but, in the alternative, the processor can be any conventional processor, controller, microcontroller, or state machine. A processor can also be implemented as a combination of computing components, such as a combination of a DSP and a microprocessor, a number of microprocessors, one or more microprocessors in conjunction with a DSP core, or any other such configuration. These examples of the processing circuit 502 are for illustration and other suitable configurations within the scope of the present disclosure are also contemplated.

The storage medium 504 can represent one or more devices for storing programming and/or data, such as executable code or instructions (e.g., software, firmware), electronic data, databases, or other digital information. The storage medium 504 can be any available media that can be accessed by a general purpose or special purpose processor. By way of example and not limitation, the storage medium 504 can include read-only memory (ROM), random access memory (RAM), magnetic disk storage mediums, optical storage mediums, flash memory devices, and/or other non-transitory computer-readable mediums for storing information. The storage medium 504 can be coupled to the processing circuit 502 such that the processing circuit 502 can read information from, and write information to, the storage medium 504. In the alternative, the storage medium 504 can be integral to the processing circuit 502.

The communications interface 506 is configured to implement wireless and/or wired communications of computer system 500. For example, in some embodiments, the communications interface 506 can be configured to communicate information bi-directionally with respect to one or more remote devices (e.g., the server system 104 in FIGS. 1-4) as well as other devices by means of a communication network (e.g., communication network 106 in FIG. 1). The communications interface 506 can be coupled with an antenna and can include wireless transceiver circuitry for wireless communications with wireless devices and can also include as a network interface card (NIC), serial or parallel connection, USB port, Firewire interface, flash memory interface, floppy disk drive, or any other suitable arrangement for communicating with respect to public (e.g., Internet) and/or private networks or other wired arrangements.

The display 508 is configured to visually present images to a user (e.g., a list of software programs). For example, the display 508 can include a monitor, television, projector, or other device for visually presenting graphics to a user.

The computer system 500 can further include a configuration detection module 510. The configuration detection module 510 is illustrated in broken lines, because it can be internal to the computer system 500 (e.g., stored in storage medium 504), external to the computer system 500 (e.g., at a server system), or a combination of internal and external. In either case, the configuration detection module 510 is adapted to cause the processing circuit 502 to identify one or more configuration details of the computer system 500. For example, the configuration detection module 510 can comprise processor executable instructions accessible by the processing circuit 502. In some implementations, the configuration detection module 510 can comprise software, software, firmware, middleware, testware, microcode or hardware, as well as any combination thereof.

As noted above, the computer system 500 can be adapted to perform one or more of the features of the computer system 102 described previously with reference to FIGS. 1-4. An example of at least one embodiment of a method operational on a computer system, such as computer system 500 is illustrated in the flow diagram of FIG. 6. Referring to both FIGS. 5 and 6, the method 600 can include determining one or more configuration details of a computer system at step 602. For example, the processing circuit 502 can be adapted to determine configuration details of the computer system 500. In at least one embodiment, the processing circuit 502 can execute instructions associated with the configuration detection module 510, which can cause the processing circuit 502 to identify one or more configuration details of the computer system 500. Upon identifying the one or more configuration details, the computer system 500 can request confirmation from a user that the configuration details are correct. If the user determines that the configuration details are not correct, the user can have the option to manually change one or more of the configuration details. The configuration details can be stored as a configuration file, for example in the storage medium 504 or in a storage medium in the server system 104, for future access and use.

At step 604, the computer system 500 can obtain a directory of a plurality of software programs. For example, the processing circuit 502 can obtain the directory of the plurality of software programs via the communications interface 506. The directory of software programs, in some implementations, can comprise the catalog of software programs that includes both compatible and non-compatible software programs without any indication of whether a software program is compatible with the computer system 500. In other implementations, the directory of software programs can comprise the list already indicating each software program that is compatible with configuration details of the computer system 500.

In implementations in which the obtained directory of software programs comprises the catalog of software programs without any indication of compatible software programs, method 500 can include an optional step 606 in which software programs that are compatible with the computer system 500 are identified in the catalog. Identifying each compatible software program can include the processing circuit 502 evaluating the system requirements associated with each software program and comparing the system requirements to the configuration details. At optional step 608, a list can be generated indicating each compatible software program. For example, the one or more system configuration details can be employed to filter out those software programs that are not compatible with the computer system 500. That is, the processing circuit 502, upon determining that a software program is compatible, can provide an indication that the software program is compatible by simply adding the software program to the list. In such embodiments, the generated list can comprise only compatible software programs. In another example, an indicator can be associated with each compatible software program. That is, the processing circuit 502, upon determining that a software program is compatible, can provide an indication that the software program is compatible by associating an indicator with the software program in the list. In such embodiments, the generated list can comprise both compatible software programs and non-compatible software programs, but a user is able to identify compatible software programs by the indicators.

After the list is generated at step 608 (e.g., in implementations in which the directory comprises the catalog of software programs), or after the directory is obtained at step 604 (e.g., in implementations where the directory comprises the list already indicating each compatible software program), the list indicating the compatible software programs can be displayed at step 610. For example, the processing circuit 502 can be adapted to display the list of software programs indicating each compatible software program with the display 508.

### Server System

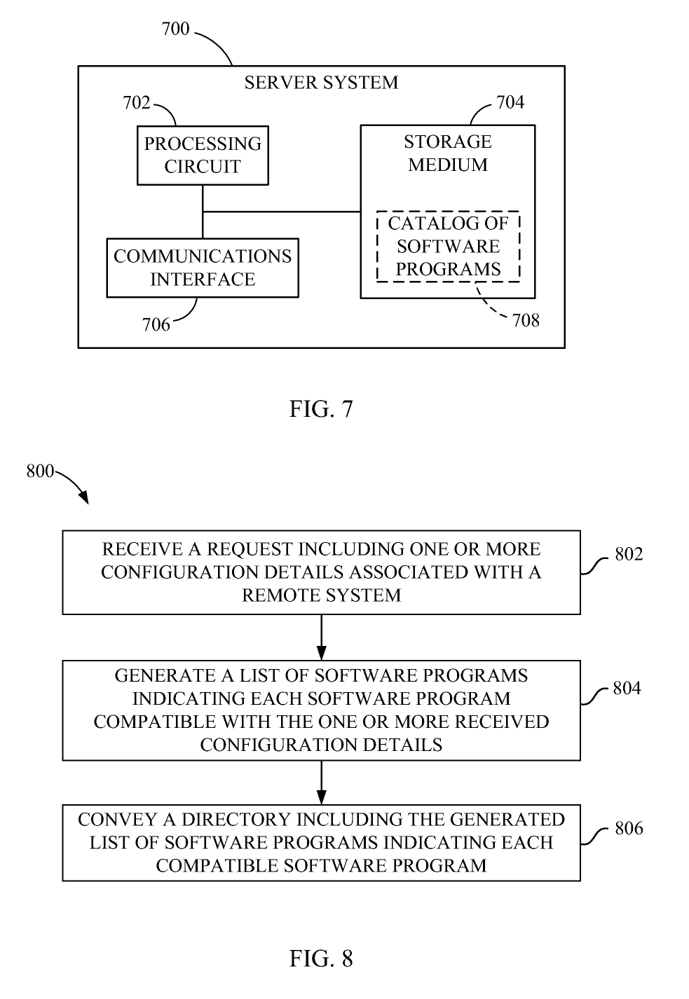

FIG. 7 is a block diagram illustrating select components of a server system 700 according to one or more embodiments. The server system 700 can be adapted to perform and/or include all of the features of the server system 104, as set forth herein above with reference to FIGS. 1-4, and can include the various server engines described with reference to FIG. 2. As illustrated in FIG. 7, the server system can include a processing circuit 702 coupled to a storage medium 704 and to a communications interface 706.

The processing circuit 702 is arranged to obtain, process and/or send data, control data access and storage, issue commands, and control other desired operations. The processing circuit 702 can comprise circuitry configured to implement desired programming provided by appropriate media in at least one embodiment. For example, the processing circuit 702 can be implemented as one or more of a processor, a controller, a plurality of processors and/or other structure configured to execute executable instructions including, for example, software and/or firmware instructions, and/or hardware circuitry. Embodiments of the processing circuit 702 can include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor can be a microprocessor but, in the alternative, the processor can be any conventional processor, controller, microcontroller, or state machine. A processor can also be implemented as a combination of computing components, such as a combination of a DSP and a microprocessor, a number of microprocessors, one or more microprocessors in conjunction with a DSP core, or any other such configuration. These examples of the processing circuit 702 are for illustration and other suitable configurations within the scope of the present disclosure are also contemplated.

The storage medium 704 can represent one or more devices for storing programming and/or data, such as executable code or instructions (e.g., software, firmware), electronic data, databases, or other digital information. A non-limiting example of a database can include a catalog of a plurality of software programs 708. The storage medium 704 can be any available media that can be accessed by a general purpose or special purpose processor. By way of example and not limitation, the storage medium 704 can include read-only memory (ROM), random access memory (RAM), magnetic disk storage mediums, optical storage mediums, flash memory devices, and/or other non-transitory computer-readable mediums for storing information. The storage medium 704 can be coupled to the processing circuit 702 such that the processing circuit 702 can read information from, and write information to, the storage medium 704. In the alternative, the storage medium 704 can be integral to the processing circuit 702. In one embodiment, a larger or complete catalog of software programs is stored on a different server system, in which case at least those software programs to be provided to computer system 500 are preferably forwarded to server system 700 from the different server system, and are stored in at least RAM memory on server system 700, for example as catalog 708, prior to being sent to computer system 500.

The communications interface 706 is configured to implement wireless and/or wired communications of the server system 700. For example, in some embodiments, the communications interface 706 can be configured to communicate information bi-directionally with respect to the one or more remote devices (e.g., computer system 102 in FIGS. 1-4) by means of a communication network (e.g., the communication network 106 in FIG. 1). The communications interface 706 can be coupled with an antenna and can include wireless transceiver circuitry for wireless communications with wireless devices and can also include as a network interface card (NIC), serial or parallel connection, USB port, Firewire interface, flash memory interface, floppy disk drive, or any other suitable arrangement for communicating with respect to public (e.g., Internet) and/or private networks or other wired arrangements.

As noted above, the server system 700 can be adapted to perform one or more of the features of the server system 104 described previously with reference to FIGS. 1-4. An example of at least one embodiment of a method operational on a server system, such as server system 700 is illustrated in the flow diagram of FIG. 8. Referring to both FIGS. 7 and 8, the method 800 can include receiving a request including one or more configuration details associated with a remote system at step 802. For example, the processing circuit 702 can be adapted to receive a request with via the communications interface 706 with one or more configuration details associated with a remote system, such as a computer system 102 (FIGS. 1-4), 400 (FIG. 4).

Upon receipt of the request, a list of software programs can be generated, which list indicates each software program that is compatible with the one or more received configuration details at step 804. For example, the processing circuit 702 can be adapted to filter out any software programs from the catalog 708 stored in the storage medium 704 that are not compatible with the received configuration details. That is, the processing circuit 702, upon determining that a software program is compatible, can provide an indication that the software program is compatible by simply adding the software program to the list. In such embodiments, the generated list can comprise only compatible software programs. In another example, the processing circuit 702 can be adapted to associate at least one indicator with each compatible software program in the catalog 708. In such embodiments, the generated list can comprise both compatible software programs and non-compatible software programs, but a user is able to identify compatible software programs by the indicators.

At step 806, the server system 700 can convey a directory including the generated list of software programs customized to indicate each compatible software program to a remote system. For example, the processing circuit 702 can convey the directory including the generated list of software programs via the communications interface 706.

In accordance with one or more of the various features disclosed herein, a user of a computer system is able to view software programs without needing to be concerned about configuration details of their computer system. The user can also download any of the software programs desired, using the displayed list. This can be especially valuable for computer systems having relatively limited capabilities (e.g., notebook computers, tablets, personal media players, smart phones, or other relatively limited data processing devices).

One or more of the components, steps, features and/or functions illustrated in FIGS. 1, 2, 3, 4, 5, 6, 7 and/or 8 can be rearranged and/or combined into a single component, step, feature or function or embodied in several components, steps, or functions. Additional elements, components, steps, and/or functions can also be added without departing from the invention. The apparatus, devices, and/or components illustrated in FIGS. 1, 2, 5 and/or 7 can be configured to perform one or more of the methods, features, or steps described in FIGS. 3, 4, 6 and/or 8. The novel algorithms described herein can also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations can be re-arranged. A process is terminated when its operations are completed. A process can correspond to a method, a function, a procedure, a subroutine, a subprogram, etc. When a process corresponds to a function, its termination corresponds to a return of the function to the calling function or the main function.

Moreover, embodiments can be implemented by hardware, software, firmware, middleware, microcode, or any combination thereof. When implemented in software, firmware, middleware or microcode, the program code or code segments to perform the necessary tasks can be stored in a machine-readable medium such as a non-transitory storage medium or other storage(s). A processor can perform the necessary tasks. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

Those of skill in the art would further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. A computer system, comprising:
a display device;
a communication interface; and
a processing circuit coupled to the display device and the communication interface, the processing circuit being adapted to:
determine one or more configuration details of the computer system;
obtain, via the communication interface, a directory of a plurality of software programs, wherein each software program is associated with a set of system requirements for the software program; and
display via the display device a list of software programs indicating each software program that has system requirements which are compatible with the configuration details of the computer system, the indicated software programs comprising compatible software programs.

2. The computer system of claim 1, wherein the obtained directory includes an indication of the compatible software programs.

3. The computer system of claim 1, wherein the obtained directory of the plurality of software programs comprises a directory of software programs without an indication of the compatible software programs, the processing circuit being further adapted to:
identify the compatible software programs in the directory of the plurality of software programs; and
generate the list of software programs indicating each compatible software program.

4. The computer system of claim 1, wherein the displayed list of software programs comprises only the compatible software programs, the compatible software programs being indicated by inclusion in the displayed list.

5. The computer system of claim 1, wherein:
the displayed list of software programs comprises both the compatible software programs and one or more non-compatible software programs; and
the compatible software programs include an indicator associated with each compatible software program.

6. The computer system of claim 5, wherein the indicator associated with each compatible software program comprises at least one of highlighting, locating the compatible software programs at the beginning of the generated list, a star, or an arrow.

7. A method operational in a computer system, comprising:
determining one or more configuration details of the computer system;
obtaining a directory of a plurality of software programs, wherein each software program is associated with a set of system requirements for the software program; and
displaying a list of software programs indicating each software program that has system requirements which are compatible with the configuration details of the computer system, the indicated software programs comprising compatible software programs.

8. The method of claim 7, wherein obtaining the directory of a plurality of software programs includes obtaining a directory of a plurality of software programs indicating the compatible software programs, and
wherein displaying the list of software programs comprises displaying the obtained directory of the plurality of software programs.

9. The method of claim 7, wherein obtaining the directory of a plurality of software programs includes obtaining a directory of a plurality of software programs without an indication of the compatible software programs, the method further comprising:
identifying the compatible software programs in the directory of the plurality of software programs; and
generating the list of software programs indicating each compatible software program.

10. The method of claim 7, wherein displaying a list of software programs indicating each compatible software program includes displaying a list of software programs comprising only the compatible software programs.

11. The method of claim 7, wherein displaying a list of software programs indicating each compatible software program includes:
displaying a list of software programs comprising both the compatible software programs and one or more non-compatible software programs; and
displaying an indicator associated with each compatible software program.

12. The method of claim 11, wherein displaying an indicator associated with each compatible software program includes displaying at least one indicator selected from a group of indicator consisting of highlighting, a star, or an arrow.

13. A computer readable medium encoded with computer readable program code, the program code comprising:
instructions operable to determine one or more configuration details of a computer system;
instructions operable to obtain a directory of a plurality of software programs, wherein each software program is associated with a set of system requirements for the software program; and
instructions operable to display a list of software programs indicating each software program that has system requirements which are compatible with the configuration details of the computer system, the indicated software programs comprising compatible software programs.

14. The computer readable medium of claim 13, wherein the instructions operable to obtain a directory of a plurality of software programs comprise instructions operable to obtain a directory of software programs without an indication of the compatible software programs, the computer readable medium further comprising:
instructions operable to identify the compatible software programs in the obtained directory of the plurality of software programs; and
instructions operable to generate the list of software programs indicating each compatible software program.

15. A server system, comprising:
a communications interface;
a storage medium storing a catalog of a plurality of software programs, wherein each software program is associated with a set of system requirements for the software program; and
a processing circuit coupled to the communications interface and the storage medium, the processing circuit adapted to:
receive, via the communications interface, a request including one or more configuration details associated with a remote system;
generate a list of software programs indicating each software program that has system requirements which are compatible with the received configuration details, the indicated software programs comprising compatible software programs; and
convey, via the communications interface, a directory including the generated list of software programs indicating each compatible software program.

16. The server system of claim 15, wherein the list of software programs in the conveyed directory includes both the compatible software programs from the catalog and non-compatible software programs from the catalog.

17. The server system of claim 15, wherein the list of software programs in the conveyed directory includes only the indicated compatible software programs.

18. The server system of claim 15, wherein the processing circuit is adapted to indicate each compatible software program by associating at least one indicator with each compatible software program.

19. The server system of claim 18, wherein the at least one indicator associated with each compatible software program comprises at least one of highlighting, locating the compatible software programs at the beginning of the generated list, a star, or an arrow.

20. A method operational in a server system, comprising:
receiving a request from a remote system, the request including one or more configuration details associated with the remote system;
generating a list of software programs indicating each software program that has system requirements which are compatible with the received configuration details, the indicated software programs comprising compatible software programs; and
conveying a directory including the generated list of software programs indicating each compatible software program.

21. The method of claim 20, wherein generating the list of software programs indicating each compatible software program includes filtering out any software programs from a catalog that are not compatible with the received configuration details.

22. The method of claim 20, wherein generating the list of software programs indicating each compatible software program includes associating at least one indicator with each compatible software program.

23. The method of claim 22, wherein associating at least one indicator with each compatible software program includes associating at least one of highlighting, a star, or an arrow.

24. A computer readable medium encoded with computer readable program code, the program code comprising:
instructions operable to receive a request from a remote system, the request including one or more configuration details associated with the remote system;
instructions operable to generate a list of software programs indicating each software program that has system requirements which are compatible with the received configuration details, the indicated software programs comprising compatible software programs; and
instructions operable to convey a directory including the generated list of software programs indicating each compatible software program.
